(19) United States
(12) Patent Application Publication
(10) Pub. No.: US 2002/0127898 A1
(43) Pub. Date: Sep. 12, 2002

(54) Connector having foldable plug and submerged plug

(75) Inventor: Chia-Fu Liu, Taoyuan Shien (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Delta Electronics, Inc., Taoyuan Shien (TW)

(21) Appl. No.: 09/909,106

(22) Filed: Jul. 19, 2001

(30) Foreign Application Priority Data
Mar. 12, 2001 (TW) 90203643

(51) Int. Cl. H01R 13/44

(52) U.S. Cl. 439/131

(57) ABSTRACT

A connector is provided for accepting a first electric signal and transmitting a second electric signal to a power-receiving device. The connector includes a main body having a receptacle, a circuit for converting the first electric signal into the second electric signal and mounted within the main body, a sliding block detachably coupled to the receptacle of the main body, a first plug disposed on a first surface of the sliding block and a second plug disposed on a second surface of the sliding block. When the first plug is switched to a first position, only the first plug receives the first electric signal. When the first plug is switched to a second position, the second plug receives the first electric signal.

### FIELD OF THE INVENTION

The present invention relates to a connector, and more particularly to a connector having a foldable and a submerged plug.

### BACKGROUND OF THE INVENTION

An electrical connector principally includes an insulating housing, a plug and a circuit mounted within the housing. The plug transmits a first electric signal, e.g. a commercial AC power supply, to the circuit for further performing rectification and/or conversion into a second electric signal, for example a low-voltage AC or DC power supply. The second power supply is provided for a power-receiving device such as a modem, a printer and a notebook. The plug of a typical connector usually has two conducting pins projected from one side of the housing. When the connector is not in use, a man is easy to get hurt by the tips of projected pins. Thus, a connector having a foldable plug has been developed. FIGS. 1(a) and 1(b) respectively show the perspective view and cross-sectional view of a typical connector having a foldable plug. Such connector includes a housing 10 and a plug 11. The housing further has a concave portion 12 near the top edge of the housing 10. When the plug 11 is folded in the concave portion 12, the connector could not be electrically connected with an external power source. However, when the plug 11 is adjusted to a position perpendicular to the housing 10, the plug 11 can be inserted into a wall socket (not shown) for accepting the commercial AC power supply. Another typical connector is shown in FIG. 1(b). Such connector is used when the power-receiving device is distant from the wall socket and thus could not be electrically connected with the commercial AC power supply by inserting the plug into the wall socket. The connector in FIG. 1(b) has a plug 21 submerging within a recess 22 at one side of a housing 20, and the plug 21 is electrically connected to the wall socket (not shown) via another socket 211, an electrical wire 212 and another plug 213. In order to more clearly describe the present invention, the plug submerging within the recess at one side of the housing is referred as “submerged plug” hereinafter.

Although the above-mentioned connectors have their own advantages, each has certain restrictions in usage. For example, the connector in FIG. 1(a) is not suitable for the condition that the wall socket is distant from the electrical appliance. Furthermore, the connector in FIG. 1(b) also requires an additional wire 212 to be connected to the wall socket even if the plug of the connector could be directly inserted into the wall socket. Thus, especially when a user travels, he needs to carry both types of connectors shown in FIGS. 1(a) and 1(b). Bringing two kinds of connectors is costly and inconvenient.

Therefore, the present invention provides a connector having a foldable plug and a submerged plug for overcoming the problems described above.

### SUMMARY OF THE INVENTION

It is an object of the present invention to provide a connector having a foldable plug and a submerged plug to be used in different conditions.

In accordance with an aspect of the present invention, the foldable plug and the submerged plug are not simultaneously conducted so as to prevent shorting.

In accordance with an aspect of the present invention, there is provided a connector for accepting a first electric signal and transmitting a second electric signal to a power-receiving device. The connector includes a main body, a circuit, a sliding block, a first plug and a second plug. The main body has a receptacle. The circuit is suitable for converting the first electric signal into the second electric signal and mounted within the main body. The sliding block is detachably coupled to the receptacle of the main body. The first plug is disposed on a first surface of the sliding block and the second plug is disposed on a second surface of the sliding block. When the first plug is switched to a first position, only the first plug receives the first electric signal. When the first plug is switched to a second position, the second plug receives the first electric signal.

Preferably, the connector is an adapter and the power-receiving device is an electrical appliance.

Preferably, the connector is a charger and the power-receiving device is a rechargeable battery.

Certainly, the connector can be mounted on an electrical appliance.

Preferably, the first plug is a foldable plug. The second plug is a submerged plug. The first position is an upright position and the second position is a folded position.

Preferably, the receptacle further includes a tenon and the sliding block further includes two grooves corresponding to the tenon.

Certainly, the sliding block can be integral with the main body.

In accordance with another aspect of the present invention, there is provided a connector for accepting a first electric signal and transmitting a second electric signal to a power-receiving device. The connector includes a main body having a receptacle, a circuit for converting the first electric signal into the second electric signal and mounted within the main body, a sliding block detachably coupled to the receptacle of the main body, a foldable plug disposed in a first surface of the sliding block, and a submerged plug disposed within a recess extending inward from a second surface of the sliding block, wherein when the foldable plug is switched to an upright position, only the foldable plug receives the first electric signal, and when the foldable plug is switched to a folded position, the submerged plug receives the first electric signal.

Preferably, the receptacle further includes a tenon and the sliding block further includes two grooves corresponding to the tenon.

Certainly, the sliding block can be integral with the main body.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a perspective view showing a connector having a foldable plug according to prior art;

FIG. 1(b) is a perspective view showing a connector having a submerged plug according to prior art;

FIG. 2(a) is a view illustrating the assembly of the connector having a foldable plug and a submerged plug according to a first preferred embodiment of the present invention;

FIG. 2(b) is a view illustrating the assembly of the connector having a foldable plug and a submerged plug according to a second preferred embodiment of the present invention;

FIG. 2(c) is a back view of the sliding block;

FIG. 3(a) is a perspective view of the connector in FIG. 2(a) when the sliding block is coupled with the main body;

FIG. 3(b) is a perspective view of the connector in FIG. 2(b) when the sliding block is coupled with the main body;

FIG. 4(a) is a sectional view illustrating the foldable plug is switched to the folded position; and

FIG. 4(b) is a sectional view illustrating the foldable plug is switched to the upright position.

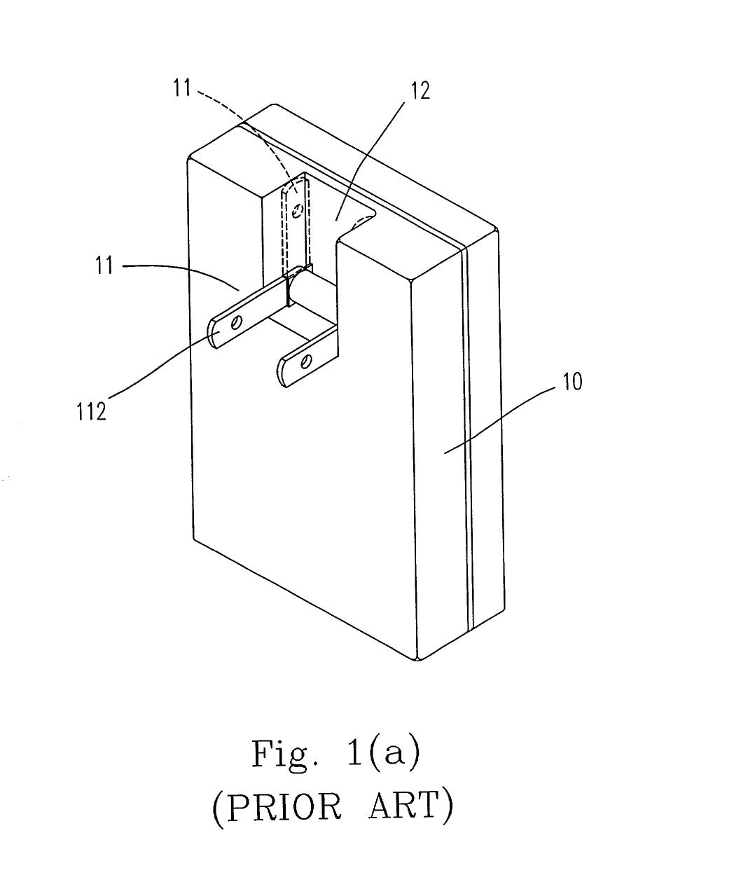

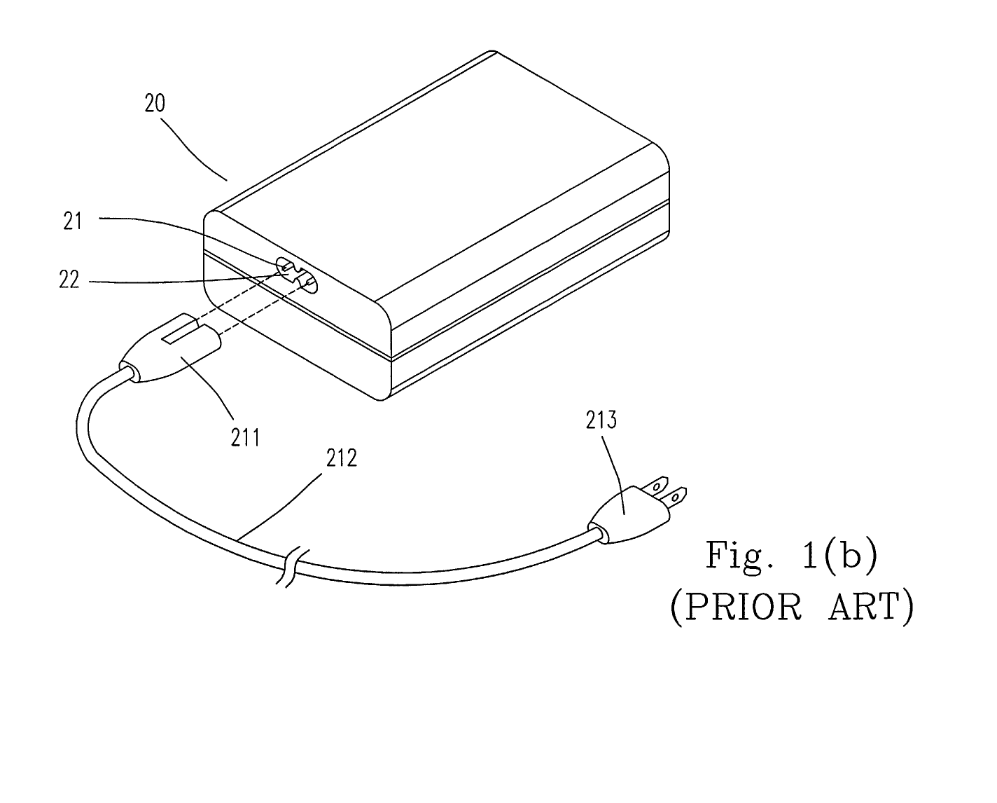

### DETAILED DESCRIPTION OF THE PREFERRED EMBODIMENT

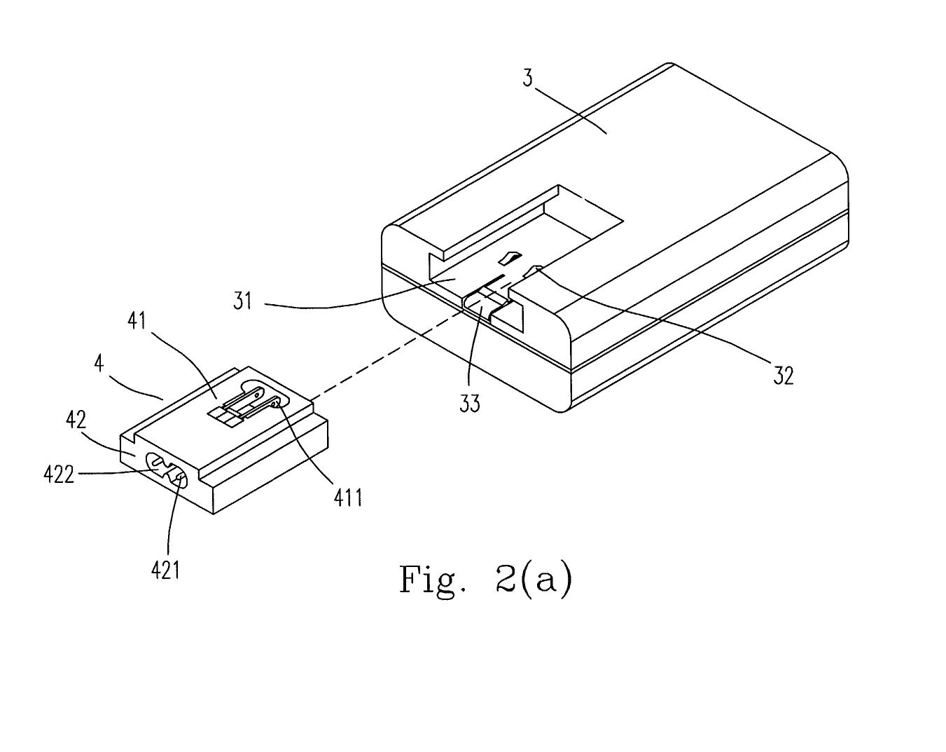

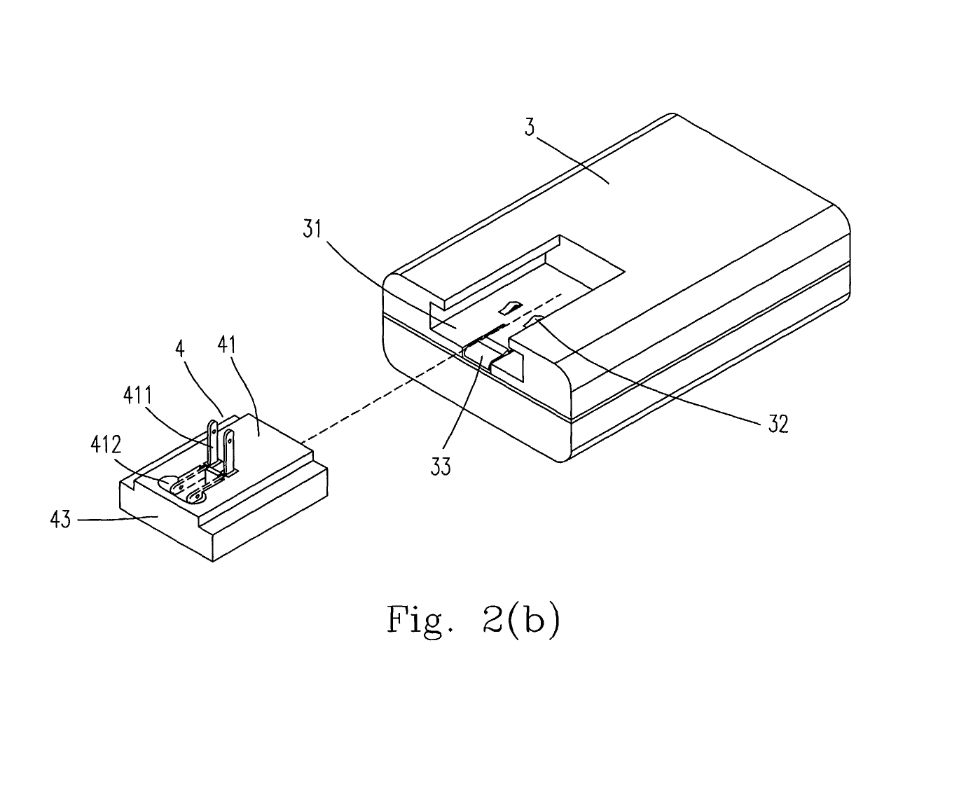

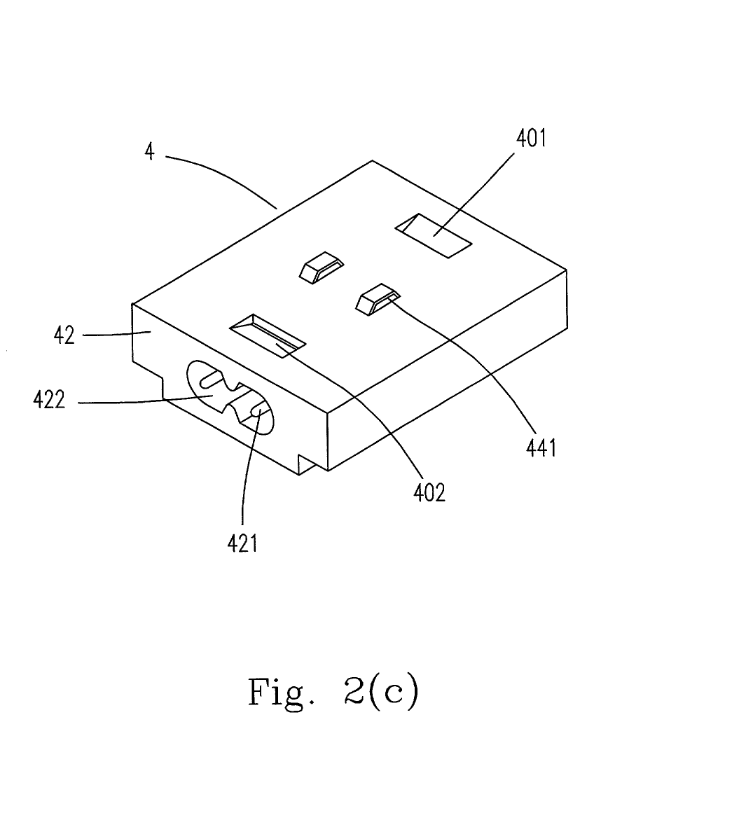

FIGS. 2(a) and 2(b) are views illustrating the assembly of connector according to a first preferred embodiment and a second preferred embodiment of the present invention, respectively. The connector according to the present invention principally includes a main body 3 and a sliding block 4. The main body 3 has a receptacle 31 which has first contact terminals 32 disposed thereon and electrically connected to a circuit (not shown) mounted within the main body 3. The sliding block 4 is detachably mounted into the receptacle 31. A top surface 41 of the sliding block 4 has a storing portion 412 for receiving a foldable plug 411, and a side surface 42 of the sliding block 4 has a submerged plug 421. In FIG. 2(a), the side surface 42 is exposed such that the submerged plug 421 can accept commercial AC power supply. Optionally, in FIG. 2(b), the other side surface 43 opposed to the side surface 42 is exposed such that the submerged plug 421 is hidden, which may be pleasing to the eye.

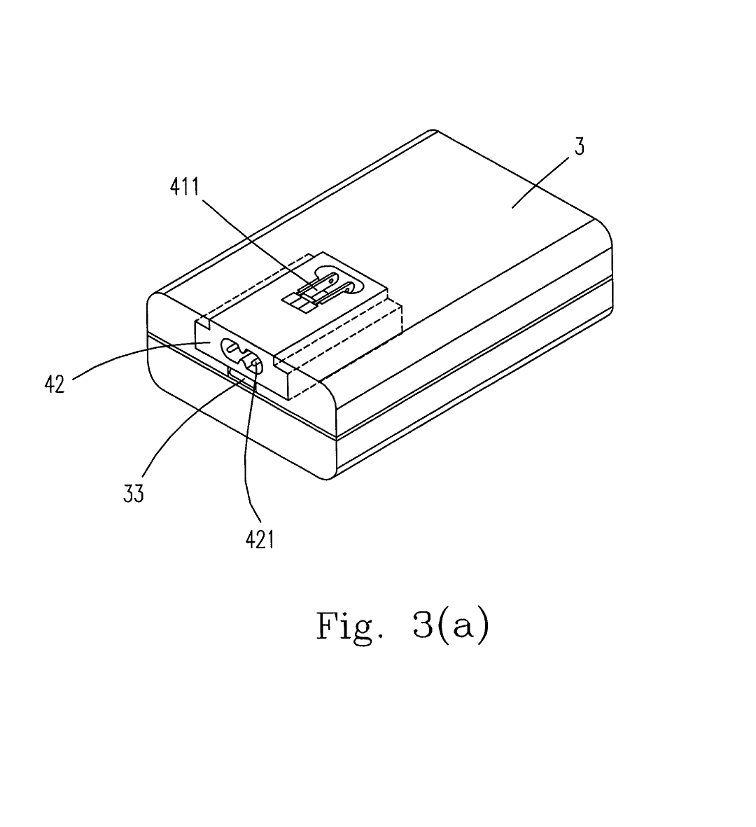

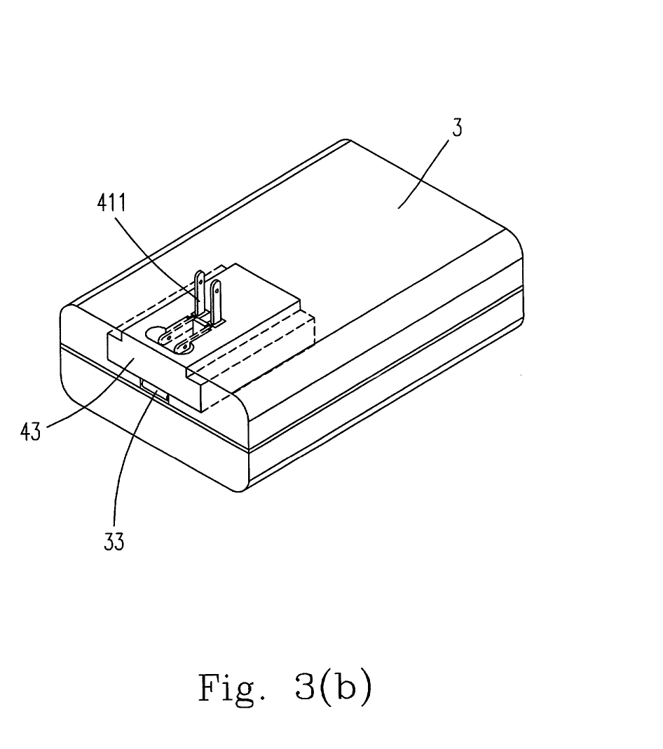

In this embodiment, each of the foldable plug 411 and the submerged plug 421 includes two pins. Certainly, each plug can have three pins and each pin can be in a shape of a sheet or a cylinder, which is dependent on the requirement of any nation. The foldable plug 411 can be operated to be securely held at a folded position or at an upright position. The term “folded position” means that the foldable plug 411 is stored within the storage portion 412 and parallels with the top surface 41 of the sliding block 4. The term “upright position” means that the foldable plug 411 is vertical to the top surface 41 of the sliding block 4 for accepting an external power supply. The submerged plug 421 is disposed within a recess 422 extending inward from the side surface 42 of the sliding block 4. In addition, the submerged plug 421 could be electrically coupled to a wall socket (not shown) via a wire. A surface under the sliding block 4 further includes second contact terminals 441 corresponding to the first contact terminals 32, as seen in FIG. 2(c). In order to facilitate the sliding block 4 to be securely held in the receptacle 31 of the main body 3, the receptacle 31 further has a tenon 33 and the sliding block 4 further includes two grooves 401 and 402 corresponding to the tenon 33. FIGS. 3(a) and 3(b) are perspective views of the connectors in FIGS. 2(a) and 2(b) respectively, wherein the sliding block 4 is coupled with the main body 3.

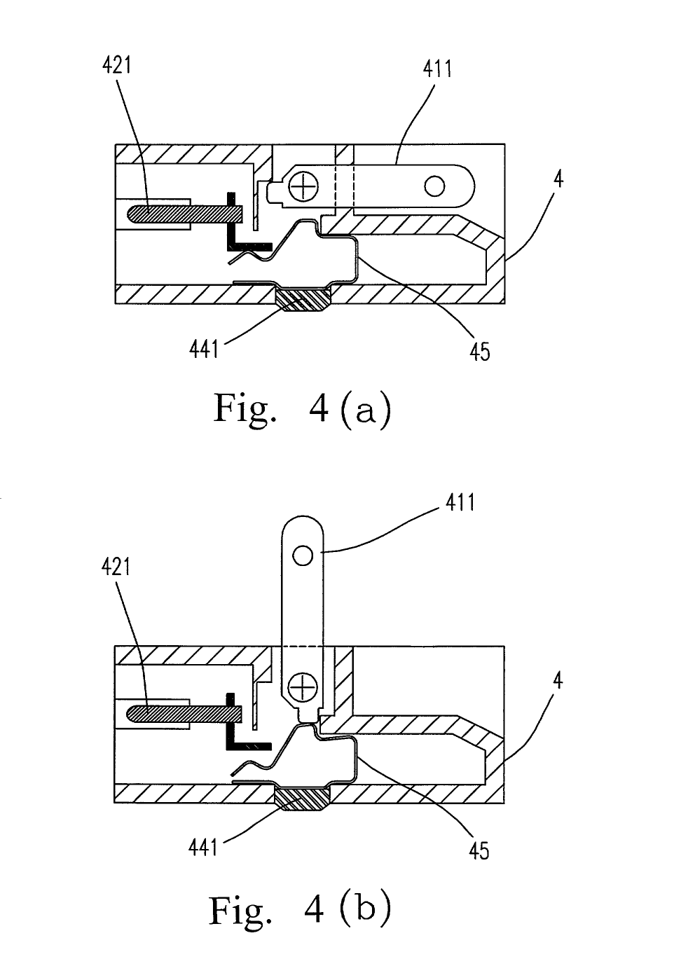

For preventing the connector of the present invention from shorting, the foldable plug 411 and the submerged plug 412 could not be simultaneously conducted. The connector of the present invention is designed to have a function that when the foldable plug 411 is switched to the upright position, only the foldable plug 411 can accept the external power supply. Please refer to FIGS. 4(a) and 4(b). According to the present invention, the structure of the connector is designed to prevent the simultaneous conduction of the foldable plug 41 and the submerged plug 44. The sliding block 4 has a metallic resilience 45 therewithin and electrically coupled to the second contact terminals 441. Referring to FIG. 4(a), when the foldable plug 411 is switched to the folded position, the metallic resilience 45 is not in contact with the foldable plug 411; however, the submerged plug 421 is electrically coupled with the metallic resilience 45. Referring to FIG. 4(b), when the foldable plug 411 is switched to the upright position, the metallic resilience 45 is pressed by the ends of the foldable plug 411 and in contact therewith. Meanwhile, the metallic resilience 45 is forced to separate from the submerged plug 421 and thus only the foldable plug 411 can accept the external power supply.

The arrangement and the operation principle of the circuit mounted within the main body 3 are known to those skilled in the art. It will be understood that the circuit is dependent on the function of the connector. For example, the circuit is used fir rectifying and/or converting the commercial AC power supply (i.e. a first electric signal) into a low-voltage AC or DC power supply (i.e. a second electric signal) for a power-receiving device. In accordance with the present invention, the connector could be one of an adapter and a charger. When the connector is an adapter, the power-receiving device is an electrical appliance such as a notebook or a printer. When the connector is applied to a charger, the power-receiving device is a rechargeable battery. Certainly, the connector of the present invention could be constructed on an electrical appliance, for example a thermos bottle or a razor, by mounting the main body 3 on a cover thereof. Certainly, the sliding block 4 can be integral with the main body 3.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A connector for accepting a first electric signal and transmitting a second electric signal to a power-receiving device, comprising:
a main body having a receptacle;
a circuit for converting said first electric signal into said second electric signal and mounted within said main body;
a sliding block detachably coupled to said receptacle of said main body;
a first plug disposed on a first surface of said sliding block; and
a second plug disposed on a second surface of said sliding block,
wherein when said first plug is switched to a first position, only said first plug receives said first electric signal, and when said first plug is switched to a second position, said second plug receives said first electric signal.

2. The connector according to claim 1, wherein said connector is an adapter.

3. The connector according to claim 2, wherein said power-receiving device is an electrical appliance.

4. The connector according to claim 1, wherein said connector is a charger.

5. The connector according to claim 4, wherein said power-receiving device is a rechargeable battery.

6. The connector according to claim 1, wherein said connector is mounted on an electrical appliance.

7. The connector according to claim 1, wherein said first plug is a foldable plug.

8. The connector according to claim 1, wherein said second plug is a submerged plug.

9. The connector according to claim 1, wherein said first position is an upright position.

10. The connector according to claim 9, wherein said second position is a folded position.

11. The connector according to claim 1, wherein said receptacle further comprises a tenon.

12. The connector according to claim 11, wherein said sliding block further comprises two grooves corresponding to said tenon.

13. The connector according to claim 1, wherein said sliding block is integral with said main body.

14. A connector for accepting a first electric signal and transmitting a second electric signal to a power-receiving device, comprising:
a main body having a receptacle;
a circuit for converting said first electric signal into said second electric signal and mounted within said main body;
a sliding block detachably coupled to said receptacle of said main body;
a foldable plug disposed in a first surface of said sliding block; and
a submerged plug disposed within a recess extending inward from a second surface of said sliding block,
wherein when said foldable plug is switched to an upright position, only said foldable plug receives said foldable electric signal, and when said foldable plug is switched to a folded position, said submerged plug receives said first electric signal.

15. The connector according to claim 14, wherein said receptacle further comprises a tenon.

16. The connector according to claim 15, wherein said sliding block further comprises two grooves corresponding to said tenon.

17. The connector according to claim 14, wherein said sliding block is integral with said main body.
